(19) United States
(12) Patent Application Publication
(10) Pub. No.: US 2025/0272356 A1
(43) Pub. Date: Aug. 28, 2025

(54) METHOD AND SYSTEM FOR SYNTHETIC DATA GENERATION

(71) Applicant: EDGEVERVE SYSTEMS LIMITED, Bangalore (IN)

(72) Inventors: Ramprasath GANESARAJA, Mahindra City (IN); Narasimha Prasad Nagaraja, Bangalore (IN); Rahul Das, Chennai (IN); Swathika Nakulan, Chennai (IN); Hannah Dotris S, Chennai (IN); Tamilzhselvan Gnanasekaran, Chennai (IN)

(21) Appl. No.: 18/661,189

(22) Filed: May 10, 2024

(30) Foreign Application Priority Data
Feb. 28, 2024 (IN) 202341069319

(51) Int. Cl. G06F 17/18

(52) U.S. Cl. CPC G06F 17/18

(57) ABSTRACT

A system and a method for synthetic data generation is provided. The system may be configured to apply a set of transformations on primary data to obtain a latent space. The latent space may be indicative of a relative distribution of a set of features in the primary data. The system may be further configured to generate a set of samples based on sampling performed on the latent space. Furthermore, the system may generate secondary data based on at least the set of samples and a defined input. The defined input may be associated with a number of data points required in the synthetic data. The system may further generate the synthetic data by use of a loss function calculated based on the secondary data and the primary data. Moreover, the system may store the synthetic data in a database.

### CROSS-REFERENCE TO RELATED APPLICATIONS

This application claims priority to Indian Patent Application number 202341069319, filed on Feb. 28, 2024, which is hereby incorporated by reference in its entirety.

### TECHNOLOGICAL FIELD

The present disclosure generally relates to synthetic data generation. More particularly, the present disclosure relates to a system and method for generation of privacy preserving synthetic data in real-time.

### BACKGROUND

Generally, synthetic data may refer to artificially created data that may be utilized in various applications. For example, the synthetic data may be utilized for training of artificial intelligence (AI) models, preserving privacy of data, secure data sharing, financial services or institutions and the like. Typically, in the financial institutions, privacy regulations often hinder sharing of sensitive data even within internal departments, thus, in such cases, the synthetic data may be utilized to share relevant information without sharing the sensitive data. Other examples of usage of the synthetic data in the financial institutions may include, but are not limited to, fraud detection, performing customer analytics and enhanced cross-institutional analysis.

Conventionally, the synthetic data may be generated by use of machine learning models. For example, generative models may be utilized to generate the synthetic data. Exemplary generative models that may be utilized are generative adversarial networks (GANs) and variational autoencoders (VAEs). However, there may be several challenges associated with using such generative models. For example, training of the generative models may require large amount of real-world data. Further, the generative models may be computationally expensive to train.

Furthermore, the generative models may be difficult to tune as multiple iterations may be required to accurately tune the generative models. Additionally, the processing time of such generative models may be high.

Another method of generation of the synthetic data may include usage of rule-based models. The rule-based models may utilize rules and constraints to generate the synthetic data. The rule-based models may also have some drawbacks associated therewith. For example, creation of the rules and constraints may be difficult. Furthermore, accuracy of the synthetic data created by use of the rule-based models may be unguaranteed. Moreover, scaling of the rule-based models to large datasets may be difficult.

In view of light of the foregoing discussion, systems and methods may be required to overcome the drawbacks associated with the conventional methods.

The information disclosed in this background of the disclosure section is only for enhancement of understanding of the general background of the technology and should not be taken as an acknowledgement or any form of suggestion that this information forms the prior art already known to a person skilled in the art.

### SUMMARY

In an embodiment, the present disclosure discloses a system for generation of synthetic data. The system may include a processor and a memory communicatively coupled to the processor. The memory stores processor-executable instructions, which, on execution, causes the processor to apply a set of transformations on primary data to obtain a latent space. The latent space may be indicative of a relative distribution of a set of features in the primary data. The processor may be further configured to generate a set of samples based on sampling performed on the latent space. Furthermore, the processor may generate secondary data based on at least the set of samples and a defined input. The defined input may be associated with a number of data points required in the synthetic data. The processor may further generate the synthetic data by use of a loss function calculated based on the secondary data and the primary data. Moreover, the processor may store the synthetic data in a database.

In some embodiments, to apply the set of transformations, the processor may be configured to apply a feature transformation on the primary data to generate a plurality of features and a set of learned parameters associated with the primary data. The plurality of features may include the set of features. The set of learned parameters may depict statistical representative data corresponding to the primary data.

In some embodiments, the processor may be configured to perform the application of the feature transformation using at least one of a factor analysis technique, a MinMax scalar technique, a standard scalar technique, a MaxAbs scalar technique, a robust scalar technique, a quantile transformer scaler technique, a log transformation technique, a power transformer scalar technique, or a unit vector scalar technique.

In some embodiments, to apply the set of transformations, the processor may be further configured to perform dimensionality reduction on the plurality of features to obtain the set of features. The processor may further apply a linear transformation on the set of features to obtain a set of basis features. The set of basis features may represent statistical equivalent data corresponding to a relationship between the set of features. The processor may further store the set of basis features in the database.

In some embodiments, the processor may be configured to perform the application of the linear transformation using covariance matrix.

In some embodiments, the processor may be configured to retrieve the set of basis features from the database. The processor may further utilize the set of samples, the basis features and the defined input to generate the secondary data.

In some embodiments, to apply the set of transformations, the processor may be further configured to apply a distribution function on the set of features to obtain the latent space.

In some embodiments, distribution function is one of a Gaussian distribution function, a Bernoulli distribution function, a uniform distribution function, a binomial distribution function, an exponential distribution function, or a Poisson distribution function.

In some embodiments, the primary data is one of tabular textual data, non-tabular textual data, image data, or audio data.

In some embodiments, the processor may be configured to perform the sampling by utilization of Markov Chain Monte Carlo (MCMC) sampling technique.

In some embodiments, to generate the synthetic data, the processor may be configured to perform N number of iterations to generate a plurality of intermittent synthetic data and calculate corresponding loss functions, until the loss function of the corresponding loss functions is determined to be more than a threshold. The threshold is based on the defined input. The processor may further select intermittent synthetic data generated in (N−1)th iteration of the N number of iterations as the generated synthetic data. The loss function corresponding to the selected intermittent synthetic data is less than the threshold.

In some embodiments, the processor may be configured to generate the plurality of intermittent synthetic data based on application of reverse feature transformation on the secondary data and utilization of a set of learned parameters associated with the primary data.

In some embodiments, processor may be configured to compare each of the plurality of intermittent synthetic data with the primary data to calculate the corresponding loss functions.

In some embodiments, the defined input is received from a user.

In another embodiment, the present disclosure discloses a method for generation of synthetic data. The method may include applying a set of transformations on primary data to obtain a latent space. The latent space may be indicative of a relative distribution of a set of features in the primary data. The method may further include generating a set of samples based on sampling performed on the latent space. The method may further include generating secondary data based on at least the set of samples and a defined input. The defined input may be associated with a number of data points required in the synthetic data. The method may further include generating the synthetic data by use of a loss function calculated based on the secondary data and the primary data. The method may further include storing the synthetic data in a database.

In some embodiments, to apply the set of transformations, the method may include applying a feature transformation on the primary data to generate a plurality of features and a set of learned parameters associated with the primary data. The plurality of features may include the set of features. The set of learned parameters may depict statistical representative data corresponding to the primary data.

In some embodiments, to apply the set of transformations, the method may further include performing dimensionality reduction on the plurality of features to obtain the set of features. The method may further include applying a linear transformation on the set of features to obtain a set of basis features. The set of basis features represent statistical equivalent data corresponding to a relationship between the set of features. The method may further include storing the set of basis features in the database.

In some embodiments, to apply the set of transformations, the method may further include applying a distribution function on the set of features to obtain the latent space.

In some embodiments, to generate the synthetic data, the method may further include performing N number of iterations to generate a plurality of intermittent synthetic data and calculate corresponding loss functions, until the loss function of the corresponding loss functions is determined to be more than a threshold. The threshold is based on the defined input. The method may further include selecting intermittent synthetic data generated in (N−1)th iteration of the N number of iterations as the generated synthetic data, wherein the loss function corresponding to the selected intermittent synthetic data is less than the threshold

In yet another embodiment, the present disclosure discloses a computer readable medium including instruction stored thereon that when processed by at least one processor cause an assessment system to perform operations. The operations may include applying a set of transformations on primary data to obtain a latent space. The latent space may be indicative of a relative distribution of a set of features in the primary data. The operations may further include generating a set of samples based on sampling performed on the latent space. The operations may further include generating secondary data based on at least the set of samples and a defined input. The defined input may be associated with a number of data points required in the synthetic data. The operations may further include generating the synthetic data by use of a loss function calculated based on the secondary data and the primary data. The operations may further include storing the synthetic data in a database

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an exemplary environment of a system configured to generate synthetic data, in accordance with some embodiments of the present disclosure;

FIG. 2 illustrates a block diagram of the system of FIG. 1, in accordance with some embodiments of the present disclosure;

FIG. 3 illustrates an exemplary diagram depicting steps for generation of the synthetic data, in accordance with some embodiments of the present disclosure; and

FIG. 4 shows an exemplary flow chart illustrating a method for generation of the synthetic data, in accordance with some embodiments of the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

In conventional systems, synthetic data may be generated by use of various methods. For example, one such method may be usage of generative models, e.g., generative adversarial networks (GANs) and variational autoencoders (VAEs). Another example may include usage of rule-based models. However, there may be several challenges associated with such conventional systems. Typically, the generative models may require large amount of real-world data for training, and the generative models may be computationally expensive to train. Furthermore, the generative models may be difficult to tune, and processing time of such generative models may also be high. Moreover, in case of the rule-based models, creation of rules and constraints for the generation of the synthetic data may be difficult. Furthermore, accuracy of the synthetic data created by such models may be unguaranteed. Moreover, scaling of the rule-based models to large datasets may be difficult.

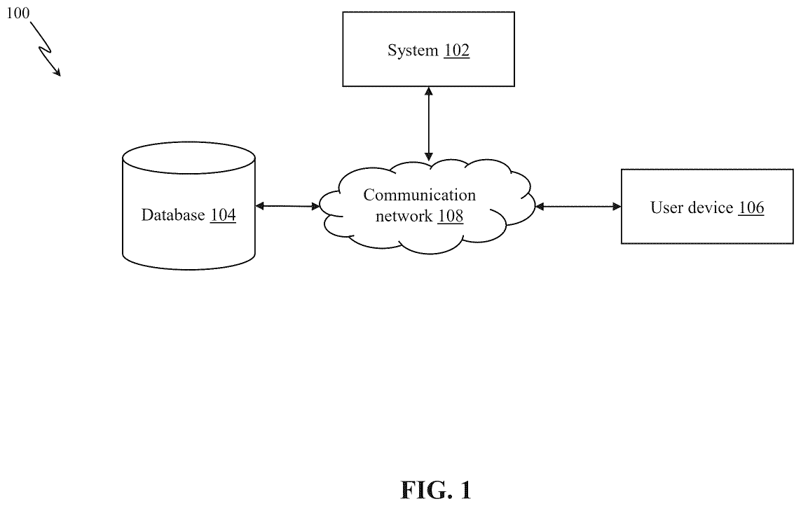

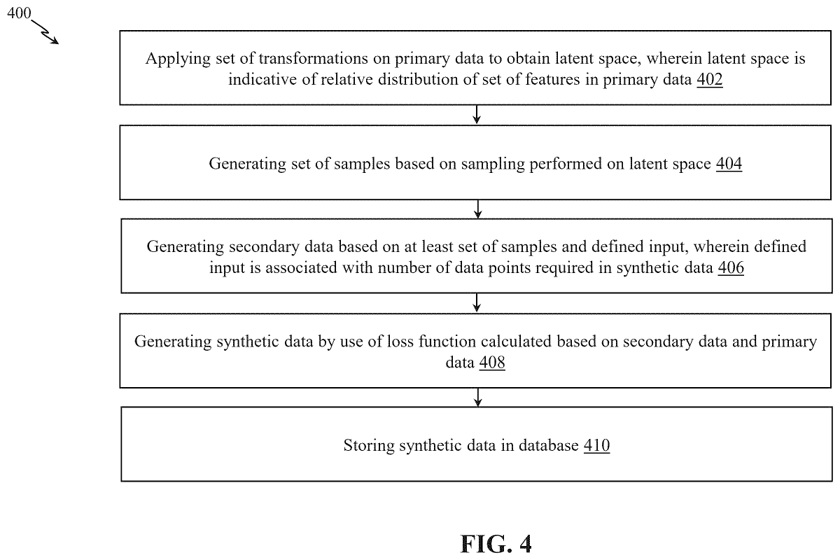

On the other hand, the proposed system of generation of the synthetic data may overcome the challenges of the conventional systems. For example, the system may utilize artificial intelligence (AI) models, for example, the system may utilize a Markov chain Monte Carlo (MCMC) sampling method to perform sampling required for the generation of the synthetic data. Such sampling methods may require minimal or less training data as compared to the conventional generative models. Thus, the proposed system may be computationally inexpensive to train as well. Moreover, the proposed system may operate in real-time or near real-time, thereby making the process of generation of the synthetic data time effective. The proposed system may further eliminate the use of rules and constraints, thereby simplifying the generation of the synthetic data and eliminating the scaling difficulties as experienced in the rule-based models. Further, the proposed system may utilize dimensionality reduction that may decrease the processing time, without compromising on a quality of data being processed. The dimensionality reduction, thus, helps in achieving accurate synthetic data. Details of the proposed system and method for generation of the synthetic data are further described, for example, with respect to FIG. 1 till FIG. 4.

FIG. 1 illustrates an exemplary environment 100 of a system 102 configured to generate synthetic data, in accordance with some embodiments of the present disclosure. The environment 100 may include the system 102, a database 104, a user device 106 and a communication network 108.

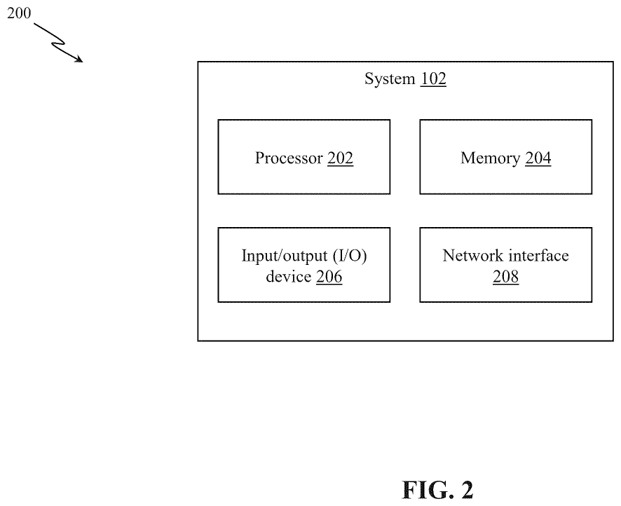

The system 102 may include suitable logic, circuitry, code, and/or interfaces that may be configured to generate the synthetic data. For example, the system 102 may be configured to apply a set of transformations on received primary data to obtain a latent space. The system 102 may further generate a set of samples based on the latent space and generate secondary data based on the set of samples. Moreover, the system 102 may utilize a loss function calculated between the secondary data and the primary data to generate the synthetic data. The synthetic data may be stored in the database 104. The system 102 may include components such as a processor, a memory, a communication interface and the like, that are further explained in FIG. 2. Examples of the system 102 may include, but are not limited to, an artificial intelligent (AI) machine, a computing device, a smartphone, a cellular phone, a mobile phone, a gaming device, a mainframe machine, a server, a computer work-station, a tablet computer, a laptop computer, a desktop computer, and/or a consumer electronic (CE) device.

The database 104 may include suitable logic, circuitry, interfaces, and/or code that may be configured to store the generated synthetic data. The database 104 may be further configured to store the primary data, a set of learned parameters, a set of basis features, intermittent synthetic data and so forth. In an embodiment, the database 104 may be a vector database. In some embodiments, the database 104 may be a relational database. In other embodiments, the database 104 may be a non-relational database. Also, in some cases, the database 104 may be stored on a server, such as a cloud server or may be cached and stored on the system 102. In some embodiments, the server of the database 104 may be configured to receive a request to provide the primary data to the system 102, via the communication network 108. In response to such request, the server of the database 104 may be configured to retrieve and provide the primary data to the system 102, via the communication network 108. Additionally, or alternatively, the database 104 may be implemented using hardware including a processor, a microprocessor (e.g., to perform or control performance of one or more operations), a field-programmable gate array (FPGA), or an application-specific integrated circuit (ASIC). In some other instances, the database 104 may be implemented using a combination of hardware and software.

The user device 106 may include suitable logic, circuitry, code, and/or interfaces that may be configured to receive a defined input. The defined input may be associated with a number of data points required in the synthetic data. In an embodiment, a user of the user device 106 may provide the defined input based on the number of data points required in the synthetic data. Examples of the user device 106 may include, but are not limited to, the AI machine, the computing device, the smartphone, the cellular phone, the mobile phone, the gaming device, the mainframe machine, the server, the computer work-station, the tablet computer, the laptop computer, the desktop computer, and/or the CE device. In one or more embodiments, the system 102 may be a part of the user device 106.

The communication network 108 may include a communication medium through which the system 102, the database 104 and the user device 106 may communicate with each other. The communication network 108 may be one of a wired connection or a wireless connection. Examples of the communication network 108 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the environment 100 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth® (BT) communication protocols.

In operation, the synthetic data may be required by the user. In an exemplary scenario, the synthetic data may be required for various applications in an organization, such as a financial institution. In such a case, the system 102 may be utilized by the user (such as an employee) of the financial institution to generate the synthetic data. The primary data may be for example, associated with several users (such as customers) of the financial institution. The primary data may include sensitive data that may need to be protected. The synthetic data may be generated by use of the primary data that may include relevant information extracted from the primary data. The extracted relevant information may be devoid of any sensitive data associated with the users. Thus, the synthetic data may be utilized for various applications instead of the actual primary data, such as data sharing and real-time fraud detection without a risk of sensitive data leakage.

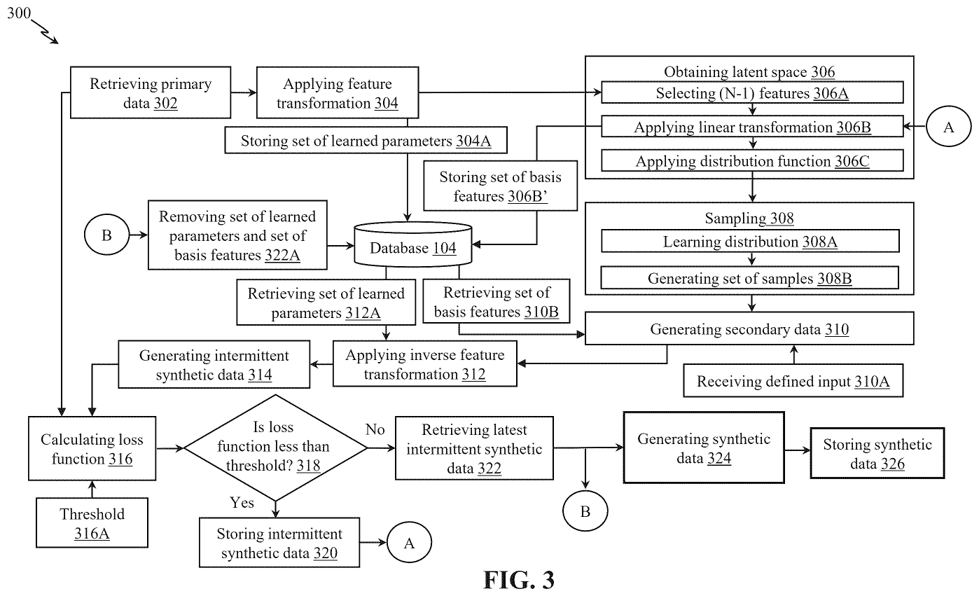

In some embodiments, the primary data may be stored in the database 104. The primary data may be for example, textual data that may include tabular data. The primary data may include information such as names, age information, geographic information, education information, credit card information, and the like associated with the users or the customers of the financial information. In an exemplary scenario, the user such as the employee of one department of the financial institution may need to share some insights associated with the primary data, without sharing the actual primary data with an employee of a second department of the financial institution. In such a case, the user such as the employee may provide a request to the system 102 to retrieve the primary data (e.g., the tabular data). The system 102 may be configured to retrieve the primary data including the details of the various customers from the database 104. Details of retrieval of the primary data are further described, for example, in at step 302 in FIG. 3.

The system 102 may further apply a set of transformations on the received primary data to obtain latent space associated with the primary data. The latent space may depict a reduced dimensionality associated with the primary data. In some embodiments, the set of transformations may include a feature transformation that may lead to generation of the set of learned parameters. The set of transformations may further include a linear transformation. That may lead to generation of the set of basis features. In an embodiment, the set of transformations may further include applying a distribution function to obtain the latent space. Details of application of the set of transformations are further described, for example, at step 304 and step 306 in FIG. 3.

The system 102 may be further configured to generate a set of samples based on sampling performed on the obtained latent space. In an embodiment, the sampling may be performed by use of an AI model. The system 102 may further generate the secondary data based on the set of samples, the set of basis features and the defined input. For example, the defined input may be received via the user device 106 from the user (e.g., the employee) of the financial institution. Details of the sampling and generation of the secondary data are further described, for example, at step 308 and step 310 respectively in FIG. 3.

The system 102 may further be configured to generate the synthetic data by use of the loss function calculated based on the generated secondary data and the retrieved primary data. In an embodiment, the system 102 may apply a transformation, such as an inverse feature transformation on the generated secondary data. The inverse feature transformation is further explained at step 312 in FIG. 3. Based on the inverse feature transformation and the set of learned parameters the system 102 may generate intermittent synthetic data as explained further at step 314 in FIG. 3.

Furthermore, in some embodiments, the system 102 may calculate the loss function between the generated intermittent synthetic data and the retrieved primary data as described further at step 316 in FIG. 3. Based on a determination that the loss function is less than or equal to a threshold, the system 102 may further iteratively apply one or more of the set of transformations on the generated intermittent synthetic data, and calculate corresponding loss functions, until a loss function of the corresponding loss functions is more than the threshold. Once the loss function is obtained to be more than the threshold, the system 102 may utilize the intermittent synthetic data. For example, such intermittent synthetic data may be a latest intermittent synthetic data (such as corresponding to (N−1)th iteration) in the performed N iterations. The system 102 may remove the set of learned parameters and the set of basis features from the latest intermittent synthetic data to generate the required synthetic data. Details of comparing the threshold, utilization of the intermittent synthetic data for further utilization and the synthetic data generation are further described, for example, at step 318, at step 320, step 322, and step 324 respectively in FIG. 3.

FIG. 2 illustrates a block diagram 200 of the system of FIG. 1, in accordance with some embodiments of the present disclosure. FIG. 2 is explained in conjunction with elements of FIG. 1. The system 102 may include a processor 202, a memory 204, an input/output (I/O) interface 206 and a communication interface 208

The processor 202 may include suitable logic, circuitry, and/or interfaces that may be configured to execute program instructions associated with different operations to be executed by the system 102. For example, some of the operations may include applying the set of transformations to obtain the latent space, generating the set of samples based on the latent space and generating the secondary data based on the set of samples. The operations may further include utilizing the loss function calculated between the secondary data and the primary data to generate the synthetic data and storing the synthetic data in the database 104. The processor 202 may include one or more specialized processing units, which may be implemented as a separate processor. In an embodiment, the one or more specialized processing units may be implemented as an integrated processor or a cluster of processors that perform the functions of the one or more specialized processing units, collectively. The processor 202 may be implemented based on a number of processor technologies known in the art. Examples of implementations of the processor 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, and/or interfaces that may be configured to store the one or more instructions to be executed by the processor 202. In accordance with an embodiment, the memory 204 may be configured to store the intermittent synthetic data temporarily until the loss function is more than or equal to the threshold. In some embodiments, the memory 204 may store the AI model, such a Markov Chain Monte Carlo (MCMC) sampling technique-based AI model utilized by the processor 202 for performing sampling. In an embodiment, the memory 204 may be configured to store all data that may be stored in the database 104 such as the generated synthetic data, the set of learned parameters, the set of basis features and the like. In some embodiments, the database 104 may be communicatively coupled to the memory 204. In some cases, the database 104 and the memory 204 may be same. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, code, and/or interfaces that may be configured to receive an input from a user and provide an output based on the received input. For example, the system 102 may receive the input to initiate the generation of the synthetic data using the primary data. In another example, the system 102 may output the generated synthetic data via I/O device 206. Examples of the I/O device 206 may include, but are not limited to, a touch screen, a keyboard, a mouse, a joystick, a microphone, a display device, and a speaker.

The network interface 208 may include suitable logic, circuitry, code, and/or interfaces that may be configured to facilitate communication between the processor 202, the database 104 and the user device 106, via the communication network 108. The network interface 208 may be implemented by use of various known technologies to support wired or wireless communication of the system 102 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet, or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

FIG. 3 illustrates an exemplary diagram 300 depicting steps for generation of the synthetic data, in accordance with some embodiments of the present disclosure. FIG. 3 is explained in conjunction with elements of FIG. 1 and FIG. 2.

As illustrated in FIG. 3, the exemplary diagram 300 may comprise one or more steps. The exemplary diagram 300 may be described in the general context of computer executable instructions. Generally, computer executable instructions can include routines, programs, objects, components, data structures, procedures, modules, and functions, which perform particular functions or implement particular abstract data types.

The order in which the exemplary diagram 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 302, the primary data may be retrieved. In some embodiments, the processor 202 may be configured to retrieve the primary data. For example, the primary data may be retrieved from the database 104. In other example, the primary data may be retrieved via other sources such as a server in communication with the system 102. Moreover, in some cases, the primary data may be locally stored in the memory 204 of the system 102. In such cases, the processor 202 may retrieve the primary data from the memory 204.

In an embodiment, the primary data may be one of tabular textual data, non-tabular textual data, image data, or audio data. In an exemplary scenario, textual data may include user information of an organization, such as customer information of the financial institution. For example, the textual data may include names, gender information, age information, location information, credit card information, educational information, statistics associated with spending patterns of the customers, and so forth. Such data may be present in the tabular form.

Furthermore, the primary data may include images comprising the customer information. For example, the image data may include application form of the customers that may include personal details such as the name, the gender, the address, bank account information and the like. Similarly, the audio data may include data associated with the customers that may be recorded with consent during conversations with the customers. In general, the data in any known format that may include the required information may be utilized. In one or more embodiments, the data in any known format may first be converted to the tabular textual data for further processing.

At step 304, the feature transformation of the set of transformations may be applied on the retrieved primary data to generate the plurality of features and the set of learned parameters. In some embodiments, the processor 202 may be configured to apply the feature transformation on the retrieved primary data to generate the plurality of features and the set of learned parameters. For example, the primary data may include various datatypes, such as characters, numbers, alphanumeric characters, and the like. By utilization of the feature transformation, such datatypes may be converted into the plurality of features (known as mean subtracted standardized numerical features) that may represent a feature space or a pure numerical space.

Moreover, the set of learned parameters may depict statistical representative data corresponding to the primary data. As an exemplary scenario, the plurality of features may include features corresponding to the gender such as “male” and “female”. In such a case, the set of learned parameters may include a value “0” corresponding to the feature “male” and a value “1” corresponding to the feature “female”. Thus, in such a manner, the plurality of features may be represented numerically by use of the set of learned parameters. A goal of the feature transformation may be to transform columns of the primary data without altering statistical properties of the primary data. Such transformation may help to achieve a desirable invertible property, that may enable retrieval of the set of learned parameters from numeric attributes of the plurality of features in subsequent one or more steps of the proposed method. In an embodiment, at step 304A, the set of learned parameters may be stored in the database 104.

In some embodiments, the processor 202 may be configured to perform the application of the feature transformation using at least one of a factor analysis technique, a MinMax scalar technique, a standard scalar technique, a MaxAbs scalar technique, a robust scalar technique, a quantile transformer scaler technique, a log transformation technique, a power transformer scalar technique, or a unit vector scalar technique. It may be noted that the application of the feature transformation may be performed by any other method known in the art. For example, the factor analysis technique may be used to reduce a large number of variables of the primary data into fewer numbers of factors to generate the plurality of features. Moreover, the MinMax scalar technique may enable scaling of the primary data in a range of 0 to 1 to generate the plurality of features. Similarly, the standard scalar technique may utilize Standard Normal Distribution (SND) to generate the plurality of features. It may be noted that the mentioned feature transformation techniques are known in the art and thus, detailed description of the feature transformation techniques has been omitted from the disclosure for the sake of brevity.

At step 306, the linear transformation of the set of transformations may be applied on a set of features of the plurality of features to obtain the latent space. In some embodiments, the processor 202 may be configured to perform the linear transformation. In an embodiment, the processor 202 may be configured to perform dimensionality reduction on the plurality of features to obtain the set of features. For example, at step 306A, the processor 202 may select (N−1) features as the set of features from the plurality of features to perform the dimensionality reduction.

At step 306B, the processor 202 may further apply the linear transformation on the set of features to obtain the set of basis features. The set of basis features may represent statistical equivalent data corresponding to a relationship between the set of features. For example, the primary data may include the feature “gender” comprising “male and female”. The primary data may further include the feature “geographical location” comprising several locations. The set of basis features may provide statistics about a number of males and a number of females associated with each of the geographical location. Thus, such relationship may be obtained in the set of basis features.

In an embodiment, the processor 202 may be configured to perform the application of the linear transformation using covariance matrix calculation. The covariance matrix may be calculated and decomposed into a rotational matrix and a scalar matrix. The rotational matrix and the scalar matrix components may be the set of basis features. The set of basis features may provide information about the directions and magnitudes of variability in the set of features. At step 306B′, the processor 202 may store the obtained set of basis features in the database 104.

At step 306C, the distribution function may be applied on the set of features. In some embodiments, the processor 202 may be configured to apply the distribution function on the set of features to obtain the latent space. The latent space may be a space where similar features of the set of features may be positioned closer to each other. The latent space may be indicative of a relative distribution of the set of features in the primary data. Thus, the latent space may depict closeness of relationship between the set of features. For example, the relationship between the feature “education information”, the feature “gender” and the feature “geographical location” of the set of features may be depicted by the latent space.

In some embodiments, the distribution function may be one of a Gaussian distribution function, a Bernoulli distribution function, a uniform distribution function, a binomial distribution function, an exponential distribution function, or a Poisson distribution function. For example, the Gaussian distribution function may convert the distribution of the linearly transformed reduced dimensions into a number of most optimized gaussian components. The optimized gaussian components may be used to represent the latent space. The proposed method using the Gaussian distribution function may identify multiple modes of the latent space by fitting multiple normal (or Gaussian) distributions Similarly, the Bernoulli distribution function may be a discrete probability distribution where a Bernoulli random variable may have only “0” or “1” as an outcome to represent the latent space. In a preferred embodiment, Gaussian distribution function may be utilized for obtaining the latent space. It may be noted that the mentioned distribution functions are known in the art and thus, detailed description of the distribution functions has been omitted from the disclosure for the sake of brevity.

At step 308, the set of samples may be generated. In some embodiments, the processor 202 may be configured to generate the set of samples based on sampling performed on the latent space. At block 308A, the processor 202 may learn distribution from the obtained latent space. At step 308B, the processor 202 may perform sampling to generate the set of samples from the learned distribution. In some embodiments, the processor 202 may be configured to perform the sampling by utilization of Markov Chain Monte Carlo (MCMC) sampling technique. The MCMC sampling technique may be an AI based sampling technique. The MCMC sampling technique performs sampling from a probability distribution. Notably, the MCMC sampling technique may include constructing a Markov chain that may have a desired distribution as its equilibrium distribution, and thus, the set of samples may be obtained from the desired distribution by recording states from the Markov chain. Such type of AI based sampling technique requires less training data and may be less computationally exhaustive as compared to the conventional generative models used for the synthetic data generation.

At step 310, the secondary data may be generated. In some embodiments, the processor 202 may be configured to generate the secondary data based on at least the set of samples and the defined input. The defined input may be associated with a number of data points required in the synthetic data. For example, the user such as the employee of the financial institution requires the synthetic data with some set number of data points. In such a case, in an embodiment, at step 310A, the defined input is received from the user, such as the employee. In one or more embodiments, the defined input may further include a threshold that may further be utilized in calculation of the loss function in subsequent steps. The user device 106 may be utilized to provide the defined input by the user. In some embodiments, the threshold may be stored in the database 104 or the memory 204.

The secondary data may include reconstructed data points from the set of samples. In some embodiments, at step 310B, the processor 202 may be configured to retrieve the set of basis features from the database 104. Based on the set of samples, the basis features and the defined input, the processor 202 may generate the secondary data. The dimensions of the secondary data may need to be similar to the dimensions as obtained during the dimensionality reduction. In an embodiment, the similar dimensions may be obtained using the linear transformation.

At step 312, reverse feature transformation may be applied on the secondary data. In some embodiments, the processor 202 may be configured to apply the reverse feature transformation on the secondary data. The reverse feature transformation may effectively project the secondary data back into the feature space of the primary data. Such reverse transformation may be necessary to maintain interpretability and meaningfulness of the obtained secondary data, especially when the primary data undergoes any form of scaling or normalization (such as the feature transformation). At step 312A, the processor 202 may retrieve the set of learned parameters from the database 104.

At step 314, the intermittent synthetic data of a plurality of intermittent synthetic data may be generated. In some embodiments, the processor 202 may be configured to generate the intermittent synthetic data based on the applied reverse feature transformation on the secondary data and utilization of the retrieved set of learned parameters associated with the primary data. The intermittent synthetic data include some features instead of the mathematical values. The features in the intermittent synthetic data may be obtained by use of the retrieved set of learned parameters.

At step 316, the loss function may be calculated. In some embodiments, the processor 202 may be configured to calculate the loss function by comparing the intermittent synthetic data and the primary data. The loss function may be calculated to determine an amount of difference between the intermittent synthetic data and the primary data beyond which the intermittent synthetic data may not be reverse engineered. After calculation of the loss function, at step 316A, the threshold is received or retrieved from the database 104 or the memory 204. For example, the threshold may indicate a numeric value that may represent a maximum value of the loss function that may be permissible. In some embodiments, the threshold may be defined by the user and may be provided in the defined input. In one or more embodiments, the threshold may be defined by the processor 202 based on the defined input that may include the required number of synthetic data points.

At step 318, the loss function may be compared with the threshold. In some embodiments, the processor 202 may be configured to compare the loss function with the threshold. The loss function may be compared with the threshold to check that the loss function is within permissible limits. In an exemplary scenario, the loss function may vary between 0 and 1. Furthermore, in an example, the threshold may range between 0.10 to 0.20. In a preferred embodiment, the threshold may be 0.15. It may be noted that the threshold may be set as per the requirements of the user, and in some cases the threshold may also lie outside the provided exemplary range.

At step 320, based on a determination that the loss function is less than the threshold, the intermittent synthetic data may be stored in a buffer. In some embodiments, the processor 202 may be configured to store the intermittent synthetic data in the buffer based on the determination that the loss function is less than the threshold. In an exemplary scenario, the threshold may be 0.15. The calculated loss function may be 0.04. Thus, in such a case, the processor 202 may store the intermittent synthetic data in the buffer.

The processor 202 may perform the N number of iterations to generate the plurality of intermittent synthetic data and the calculation of corresponding loss functions, until the loss function corresponding to an Nth iteration of the N number of iterations is determined more the threshold. For example, in each of the iteration, the processor 202 may reduce the dimension of the stored intermittent synthetic data by 1, and again continue the process of obtaining the latent space, the set of samples, the secondary data, and the loss function iteratively. Such iterative process may be repeated with each time reducing the dimensionality by 1, until the loss function is more than or equal to the threshold. For example, the iterations may be first, second, third, . . . up to Nth. The dimension in the first iteration may be reduced by 1, the dimension in the second iteration may be reduced by 2, the dimension in the third iteration may be reduced by 3, and so on.

In an exemplary scenario, in the first iteration, the calculated loss function may be 0.04, in the second iteration, the calculated loss function may be 0.07, in the third iteration, the calculated loss function may be 0.12, and so forth. The iterative process may continue until the calculated loss function is more than the threshold, such as for example, more than 0.15. For example, in the Nth iteration, the calculated loss function may be 0.18 that is more than the threshold of 0.15. Thus, the processor 202 may perform the iterations up to N.

At step 322, based on a determination that the loss function is more than or equal to the threshold in the Nth iteration, the intermittent synthetic data corresponding to the (N−1)th iteration may be retrieved from the database 104. In some embodiments, the processor 202 may be configured to retrieve the intermittent synthetic data from the database 104 based on the determination that the loss function is more than or equal to the threshold. In an exemplary scenario, the calculated loss function corresponding to the Nth iteration is determined to be 0.18 that is more than the threshold of 0.15. In such a case, the intermittent synthetic data corresponding to the (N−1)th iteration may be retrieved from the database 104. The retrieved intermittent synthetic data may be latest intermittent synthetic data in the plurality of intermittent synthetic data at which the loss function was still determined to be within the permissible limits. For example, the last determined loss function at the (N−1)th iteration may be 0.12 determined less than the threshold of 0.15. In such a case, the intermittent synthetic data corresponding to the loss function of 0.12 may be retrieved. Further, at step 322A, the set of learned parameters and the set of basis features may be removed from the retrieved intermittent synthetic data. The removal may ensure privacy maintenance of the primary data.

At step 324, the synthetic data may be generated. In some embodiments, the processor 202 may select the intermittent synthetic data corresponding to the (N−1)th iteration as the synthetic data. Thus, in such a manner, the processor 202 may generate the synthetic data by use of the loss function calculated based on the secondary data and the primary data.

At step 326, the generated synthetic data may be stored in the database 104. In some embodiments, the processor 202 may be configured to store the generated synthetic data in the database 104. The stored synthetic data may be utilized for various purposes such as real-time fraud detection, privacy-preserving data exchange of the primary data and so forth.

Further presented is an exemplary scenario of the proposed method. The proposed method is explained by use of an exemplary tabular data used as the primary data as shown below. It may be noted that the exemplary tabular data is used only for illustrative purposes, and in real life applications the primary data may have a much larger dimensionality and may be more complex in nature.

In the exemplary scenario, the primary data may be the tabular data comprising N number of columns. For example, N number of columns may be “4”. The primary data is depicted in Table 1.

TABLE 1
Primary data

| | Educational | | |
|---|---|---|---|
| Gender | qualification | Geography | Age |
| Male | Graduate | Bengaluru | 23 |
| Female | PhD | Bengaluru | 27 |
| Female | PhD | Chennai | 32 |
| Female | PhD | Chennai | 29 |
| Male | Graduate | Chennai | 22 |

The proposed method may further include applying the feature transformation on the primary data. The feature transformation enables the columns of the Table 1 having string values to be converted in unique numerical identifiers. The output of the feature transformation is depicted in Table 2.

TABLE 2
Feature transformation on the primary data

| | | Educational | Educational | | | |
|---|---|---|---|---|---|---|
| Gender | Gender | qualification | qualification | Geography | Geography | |
| (F) | (M) | (Graduate) | (PhD) | (Bengaluru) | (Chennai) | Age |
| 0 | 1 | 1 | 0 | 1 | 0 | 23 |
| 1 | 0 | 0 | 1 | 1 | 0 | 27 |
| 1 | 0 | 0 | 1 | 0 | 1 | 32 |
| 1 | 0 | 0 | 1 | 0 | 1 | 29 |
| 0 | 1 | 1 | 0 | 0 | 1 | 22 |

As shown in Table 2, after the feature transformation, the values are assigned to the columns having the string values. For example, for the column “Gender”, the string values “Female” and “Male” may be converted into “1” and “0”, respectively. Similarly, the column “Educational qualification” with the values “Graduate” and “PhD” may be converted to ‘1’s and ‘0’s and so forth. The values of the categorical columns or the plurality of features may be converted into independent columns represented by 0's and 1's. For example, the Gender (Male, Female) may be two different columns as shown in Table 2. The feature transformation may provide us with the set of learned parameters that depicts the statistical representation of the plurality of features.

After the feature transformation, the linear transformation may be applied. The output of the linear transformation is depicted in Table 3.

TABLE 3
Linear transformation on the primary data

| Gender & Educational | | | |
|---|---|---|---|
| qualification (0 = Male & | Geography | Geography | |
| Graduate, 1 = Female & PhD) | (Bengaluru) | (Chennai) | Age |
| 0 | 1 | 0 | 23 |
| 1 | 1 | 0 | 27 |
| 1 | 0 | 1 | 32 |
| 1 | 0 | 1 | 29 |
| 0 | 0 | 1 | 22 |

In real world, data distribution may tend to form a pattern, not distributed in all possible scenarios equally. Thus, the proposed method may include calculating covariance matrix for the linear transformation of the primary data. In such a manner, the method enables identification of internal relationship between the set of features or the columns of the primary data (dataset). Thereby, helpings to reduce the dimensionality of the dataset. Thus, deriving the (N−1) features or the set of features of the plurality of features. It may be noted that, for illustration purpose only, the Gender and Educational qualification columns are identified as closely related columns and hence combined. Table 3 represents the obtained set of basis features as the output of the linear transformation. Further the distribution function may be applied on the (N−1) features to obtain the latent space as depicted in Table 4.

TABLE 4
Distribution function application to obtain latent space

| | | | |
|---|---|---|---|
| 7.3254 | 5.4343 | 4.45455 | 5.434 |
| 2.3453 | 5.3456 | 5.454567 | 5.453 |
| 5.34322 | 4.34654 | 6.45634 | 5.434 |
| 3.46334 | 3.45565 | 5.4345 | 3.345 |
| 5.45645 | 4.545 | 4.34324 | 5.34343 |

Table 4 represents the exemplary values obtained based on application of the Gaussian distribution on the (N−1) features. The values may represent the relations between the columns or the set of features of the dataset and may not represent the actual values.

Post obtainment of the latent space, the method may include generating the set of samples. For example, the set of samples may be generated by use of the MCMC sampling technique. It may be noted that the set of samples may have the same number of dimensions as that of the primary data, such as in this case is “4”. Based on the set of samples, the method may include generating the secondary data (such as the reconstructed data points). The secondary data is depicted in Table S.

TABLE 5
Generated secondary data

| Gender & Educational | | | |
|---|---|---|---|
| qualification (0 = Male & | Geography | Geography | |
| Graduate, 1 = Female & PhD) | (Bengaluru) | (Chennai) | Age |
| 0 | 1 | 0 | 32 |
| 1 | 1 | 0 | 23 |
| 1 | 0 | 1 | 24 |
| 1 | 0 | 1 | 27 |
| 0 | 0 | 1 | 32 |

The method may include generating the secondary data depicted in Table 5 by use of the set of samples retrieved from the database 104 and the defined input received from the user via the user device 106. For example, the defined input may include requirement of “P” number of the data points in the secondary data. In such a case, Table 5 depicts the “P” number of the data points.

The method may further include generating the intermittent synthetic data based on application of the reverse feature transformation on the secondary data and utilization of the set of learned parameters retrieved from the database 104. Table 6 depicts the reverse feature transformed secondary data.

TABLE 6
Reverse feature transformed secondary data

| | | Educational | Educational | | | |
|---|---|---|---|---|---|---|
| Gender | Gender | qualification | qualification | Geography | Geography | |
| (F) | (M) | (Graduate) | (PhD) | (Bengaluru) | (Chennai) | Age |
| 0 | 1 | 1 | 0 | 1 | 0 | 32 |
| 1 | 0 | 0 | 1 | 1 | 0 | 23 |
| 1 | 0 | 0 | 1 | 0 | 1 | 24 |
| 1 | 0 | 0 | 1 | 0 | 1 | 27 |
| 0 | 1 | 1 | 0 | 0 | 1 | 32 |

The intermittent synthetic data may be generated by use of the set of learned parameters retrieved from the database 104. Based on the set of learned parameters, the numeric values may again be converted into the string values that may represent the intermittent synthetic data. The loss may be calculated for the intermittent synthetic data and the primary data (original data).

Based on the determination that the loss is less than the threshold, the intermittent synthetic data may be stored in the buffer. The method may further include again combining another set of closely related features or columns from the set of features together and selecting next (N−2) features, i.e., reducing the dimensionality. Thus, the steps may again be repeated in a loop, i.e., the construction of the latent space based on the distribution function, the sampling, the reverse feature engineering and the calculation of the loss and comparison of the loss to the threshold. The loop may continue until the loss that is more than or equal to the threshold. Once loss that is more than or equal to the threshold, the previously (latest) stored synthetic data of the (N−1)th iteration may be retrieved and may be considered as the generated synthetic data.

FIG. 4 shows an exemplary flow chart illustrating a method 400 for generation of the synthetic data, in accordance with some embodiments of the present disclosure. FIG. 4 is explained in conjunction with elements of FIG. 1, FIG. 2 and FIG. 3.

As illustrated in FIG. 4, the method 400 may comprise one or more steps. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 402, the method may include applying the set of transformations on the primary data obtain the latent space. The latent space may be indicative of the relative distribution of the set of features in the primary data. In some embodiments, the processor 202 may be configured to apply the set of transformations on the primary data obtain the latent space. Details of application of the set of transformations are further described, for example, in FIG. 3.

At step 404, the method may include generating the set of samples based on the sampling performed on the latent space. In some embodiments, the processor 202 may be configured to generate the set of samples based on the sampling performed on the latent space. In an embodiment, the sampling may be performed by use of the MCMC sampling technique. Details of the sampling are further described, for example, in FIG. 3.

At step 406, the method may include generating the secondary data based on at least the set of samples and the defined input. In some embodiments, the processor 202 may be configured to generate the secondary data based on at least the set of samples and the defined input. The defined input may be associated with the number of data points required in the synthetic data. Details of generation of the secondary data are further described, for example, in FIG. 3.

At step 408, the method may include generating the synthetic data by use of the loss function calculated based on the secondary data and the primary data. In some embodiments, the processor 202 may be configured to generate the synthetic data by use of the loss function calculated based on the secondary data and the primary data. Specifically, the processor 202 may calculate the loss function between the intermittent synthetic data generated by use of the secondary data and the retrieved primary data. Details of generation of the synthetic data are further described, for example, in FIG. 3.

At step 410, the method may include storing the synthetic data in the database 104. In some embodiments, the processor 202 may be configured to store the generated synthetic data. In an example, the generated synthetic data may be utilized to various applications. Details of storage of the synthetic data are further described, for example, in FIG. 3.

Further, some practical applications of the generated synthetic data in the domain of the financial institutions are provided. The synthetic data generation in the financial institutions may be used to address challenge of protecting personal information while still being able to perform various data-driven tasks and analyses. Following are a few applications of the proposed method of synthetic data generation in a context of hiding or securing the personal information of the users in the banking domain.

Real time fraud detection: Conventional solutions may rely heavily on neural networks, necessitating substantial amounts of training data and extended processing time. Thus, the existing systems may be unsuitable for dynamic nature of the financial institutions fraud detection needs. However, the proposed system and the method of generation of the synthetic data may overcome such challenges. For example, the proposed method may include generation of the synthetic data in real-time or near real-time as usage of the complex neural networks may be eliminated. Moreover, the proposed method may utilize the MCMC sampling method that may require less amount of the training data as compared to the conventional neural networks. Therefore, the proposed method may enable minimization of the required training data and reduction in the time necessary for the training, thereby, empowering the financial institutions to promptly detect and combat any fraud in a highly efficient and effective manner.

Privacy preserving data exchange: The financial institutions may often face privacy concerns when sharing sensitive transaction data. The proposed system and method for the synthetic data generation may enable the financial institutions to generate the synthetic data that may closely mimics characteristics and patterns of the primary data (such as the real data), while protecting the privacy of individual transactions. In such a manner, the synthetic data may be securely shared among the financial institutions without revealing sensitive information, enabling collaborations and data-driven analysis.

Enhanced cross institutional analysis: By sharing the generated synthetic data across multiple financial institutions, collaborative analysis and insights may be gained without the need to exchange actual transaction data. The financial institutions may collectively analyze the synthetic data, identifying patterns, trends, and anomalies related to fraud. Such collaboration may lead to a more comprehensive understanding of fraudulent activities and facilitate the development of effective fraud detection models and strategies.

It may be noted that, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, bard drives, Compact Disc Read-Only Memory (CD ROMs), Digital Video Disc (DVDs), flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the technology.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the technology need not include the device itself

The illustrated operations of FIG. 3 and FIG. 4 show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the technology be limited not by this detailed description, but rather by any claims that issue on an application based here on. Accordingly, the disclosure of the embodiments of the technology is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A system for generation of synthetic data, the system comprising:
a processor; and
a memory, communicatively coupled to the processor, wherein the memory stores processor-executable instructions, which, on execution, causes the processor to:
apply a set of transformations on primary data to obtain a latent space, wherein the latent space is indicative of a relative distribution of a set of features in the primary data;
generate a set of samples based on sampling performed on the latent space;
generate secondary data based on at least the set of samples and a defined input, wherein the defined input is associated with a number of data points required in the synthetic data;
generate the synthetic data by use of a loss function calculated based on the secondary data and the primary data; and
store the synthetic data in a database.

2. The system of claim 1, wherein, to apply the set of transformations, the processor is configured to apply a feature transformation on the primary data to generate a plurality of features and a set of learned parameters associated with the primary data,
and wherein the plurality of features comprises the set of features,
and wherein the set of learned parameters depict statistical representative data corresponding to the primary data.

3. The system of claim 2, wherein the processor is configured to perform the application of the feature transformation using at least one of: a factor analysis technique, a MinMax scalar technique, a standard scalar technique, a MaxAbs scalar technique, a robust scalar technique, a quantile transformer scaler technique, a log transformation technique, a power transformer scalar technique, or a unit vector scalar technique.

4. The system of claim 2, wherein, to apply the set of transformations, the processor is further configured to:
perform dimensionality reduction on the plurality of features to obtain the set of features;
apply a linear transformation on the set of features to obtain a set of basis features, wherein the set of basis features represent statistical equivalent data corresponding to a relationship between the set of features; and
store the set of basis features in the database.

5. The system of claim 4, wherein the processor is configured to perform the application of the linear transformation using covariance matrix calculation.

6. The system of claim 4, wherein the processor is configured to:
retrieve the set of basis features from the database; and
utilize the set of samples, the basis features and the defined input to generate the secondary data.

7. The system of claim 1, wherein to apply the set of transformations, the processor is further configured to apply a distribution function on the set of features to obtain the latent space.

8. The system of claim 7, wherein the distribution function is one of: a Gaussian distribution function, a Bernoulli distribution function, a uniform distribution function, a binomial distribution function, an exponential distribution function, or a Poisson distribution function.

9. The system of claim 1, wherein the primary data is one of: tabular textual data, non-tabular textual data, image data, or audio data.

10. The system of claim 1, wherein the processor is configured to perform the sampling by utilization of Markov Chain Monte Carlo (MCMC) sampling technique.

11. The system of claim 1, wherein, to generate the synthetic data, the processor is configured to:
perform N number of iterations to generate a plurality of intermittent synthetic data and calculate corresponding loss functions, until the loss function of the corresponding loss functions is determined to be more than a threshold, wherein the threshold is based on the defined input, and
select intermittent synthetic data generated in (N−1)th iteration of the N number of iterations as the generated synthetic data, wherein the loss function corresponding to the selected intermittent synthetic data is less than the threshold.

12. The system of claim 11, wherein the processor is configured to generate the plurality of intermittent synthetic data based on application of reverse feature transformation on the secondary data and utilization of a set of learned parameters associated with the primary data.

13. The system of claim 11, wherein the processor is configured to compare each of the plurality of intermittent synthetic data with the primary data to calculate the corresponding loss functions.

14. The system of claim 1, wherein the defined input is received from a user.

15. A method of generation of synthetic data, comprising:
applying a set of transformations on primary data to obtain a latent space, wherein the latent space is indicative of a relative distribution of a set of features in the primary data;
generating a set of samples based on sampling performed on the latent space;
generating secondary data based on at least the set of samples and a defined input, wherein the defined input is associated with a number of data points required in the synthetic data;
generating the synthetic data by use of a loss function calculated based on the secondary data and the primary data; and
storing the synthetic data in a database.

16. The method of claim 15, wherein to apply the set of transformations, the method comprises applying a feature transformation on the primary data to generate a plurality of features and a set of learned parameters associated with the primary data,
and wherein the plurality of features comprises the set of features,
and wherein the set of learned parameters depict statistical representative data corresponding to the primary data.

17. The method of claim 15, wherein to apply the set of transformations, the method further comprises:
performing dimensionality reduction on the plurality of features to obtain the set of features;
applying a linear transformation on the set of features to obtain a set of basis features, wherein the set of basis features represent statistical equivalent data corresponding to a relationship between the set of features; and
storing the set of basis features in the database.

18. The method of claim 15, wherein to apply the set of transformations, the method further comprises applying a distribution function on the set of features to obtain the latent space.

19. The method of claim 15, wherein to generate the synthetic data, the method comprises:
performing N number of iterations to generate a plurality of intermittent synthetic data and calculate corresponding loss functions, until the loss function of the corresponding loss functions is determined to be more than a threshold, wherein the threshold is based on the defined input, and
selecting intermittent synthetic data generated in (N−1)th iteration of the N number of iterations as the generated synthetic data, wherein the loss function corresponding to the selected intermittent synthetic data is less than the threshold.

20. A non-transitory computer readable medium including instruction stored thereon that when processed by at least one processor cause an assessment system to perform operations comprising:
applying a set of transformations on primary data to obtain a latent space, wherein the latent space is indicative of a relative distribution of a set of features in the primary data;
generating a set of samples based on sampling performed on the latent space;
generating secondary data based on at least the set of samples and a defined input, wherein the defined input is associated with a number of data points required in the synthetic data;
generating the synthetic data by use of a loss function calculated based on the secondary data and the primary data; and
storing the synthetic data in a database.
